(19) United States
(12) Patent Application Publication
(10) Pub. No.: US 2016/0242127 A1
(43) Pub. Date: Aug. 18, 2016

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Yuichi Kakishima, Tokyo (JP); Tooru Uchino, Tokyo (JP); Hideaki Takahashi, Tokyo (JP)

(73) Assignee: NTT DOCOMO, INC., Tokyo (JP)

(21) Appl. No.: 15/024,745

(22) PCT Filed: Sep. 16, 2014
(86) PCT No.: PCT/JP2014/074413

§ 371 Date: Mar. 24, 2016

(30) Foreign Application Priority Data
Sep. 26, 2013 (JP) 2013-200400

(51) Int. Cl. H04W 52/36; H04W 72/04

(52) U.S. Cl. CPC H04W 52/365; H04W 72/04

(57) ABSTRACT

The present invention is designed to enable adequate transmission power control when inter-base station CA is employed. When inter-base station CA is employed, radio base stations detect when a user terminal's transmission power reaches the maximum transmission power, and execute control to cancel this. For example, a user terminal has a transmission section that transmits an uplink physical channel to each component carrier, a power headroom generating section that generates power headroom, which is extra transmission power of the subject terminal, and a control section that, when the value of the power headroom becomes 0 or less, executes control so that the power headroom is triggered and reported to the radio base stations.

### TECHNICAL FIELD

The present invention relates to a user terminal and a radio communication method in a next-generation mobile communication system.

### BACKGROUND ART

In LTE (Long Term Evolution) and successor systems of LTE (referred to as, for example, “LTE-advanced,” “FRA (Future Radio Access),” “4G,” etc.), a radio communication system (referred to as, for example, a “HetNet” (Heterogeneous Network)) to place small cells (including pico cells, femto cells and so on) having relatively small coverages of a radius of approximately several meters to several ten meters, in a macro cell having a relatively large coverage of a radius of approximately several hundred meters to several kilometers, is under study (see, for example, non-patent literature 1).

For this radio communication system, a scenario to use the same frequency band in both the macro cell and the small cells (also referred to as, for example, “co-channel”) and a scenario to use different frequency bands between the macro cell and the small cells (also referred to as, for example, “separate frequencies”) are under study. To be more specific, the latter scenario is under study to use a relatively low frequency band (for example, 2 GHz) in the macro cell, and use a relatively high frequency band (for example, 3.5 GHz or 10 GHz) in the small cells.

### CITATION LIST

### Non-Patent Literature

Non-patent Literature 1: 3GPP TR 36.814 “E-UTRA Further Advancements for E-UTRA Physical Layer Aspects”

### SUMMARY OF INVENTION

### Technical Problem

In LTE Rel. 10/11, coordinated multi-point transmission/reception (CoMP) technology and carrier aggregation (CA) technology are introduced.

Up to LTE Rel. 11, intra-base station CoMP/CA (intra-eNB CoMP/CA), which is premised upon controlling CoMP and CA by using one scheduler between multiple cells, is under study. In LTE Rel. 12, inter-base station CoMP/CA (Inter-eNB CoMP/CA), which provides each of multiple cells with a separate scheduler and controls CoMP and CA on a per cell basis, is under study.

In inter-base station CoMP/CA, there is a possibility that two base stations allocate uplink transmission to one user terminal separately and simultaneously. In this case, there is a threat that excess resources are allocated and cause a shortage of transmission power.

The present invention has been made in view of the above, and it is therefore an object of the present invention to provide a user terminal and a radio communication method that enable adequate execution of transmission power control especially when inter-base station CA is employed.

### Solution to Problem

The user terminal of the present invention provides a user terminal that communicates by applying carrier aggregation, in which a plurality of radio base stations, connected via non-ideal backhauls, are each made a component carrier, and this user terminal has a transmission section that transmits an uplink physical channel to each component carrier, a power headroom generating section that generates power headroom, which is extra transmission power of the subject terminal, and a control section that, when the value of the power headroom becomes 0 or less, executes control so that the power headroom is triggered and reported to the radio base stations.

### Advantageous Effects of Invention

According to the present invention, it is possible to execute transmission power control adequately when inter-base station CA is employed.

### BRIEF DESCRIPTION OF DRAWINGS

FIG. 1 provides conceptual diagrams of a HetNet;

FIG. 2A is a conceptual diagram of intra-base station CoMP/CA, and FIG. 2B is a conceptual diagram of inter-base station CoMP/CA;

FIG. 3 provides conceptual diagrams to explain extra transmission power PH of a user terminal;

FIG. 4 is a conceptual diagram to explain extra transmission power PH of a user terminal;

FIG. 5 provides conceptual diagrams to explain extra transmission power PH of a user terminal;

FIG. 6 provides diagrams to explain regular PH and specific PH in a first example;

FIG. 7 is a diagram to explain the reporting of the volume of uplink resource allocation in the first example;

FIG. 8 is a schematic diagram to show an example of a radio communication system according to the present embodiment;

FIG. 9 is a diagram to explain an overall structure of a radio base station according to the present embodiment;

FIG. 10 is a diagram to explain a functional structure of a radio base station according to the present embodiment;

FIG. 11 is a diagram to explain an overall structure of a user terminal according to the present embodiment; and

FIG. 12 is a diagram to explain a functional structure of a user terminal according to the present embodiment.

### DESCRIPTION OF EMBODIMENTS

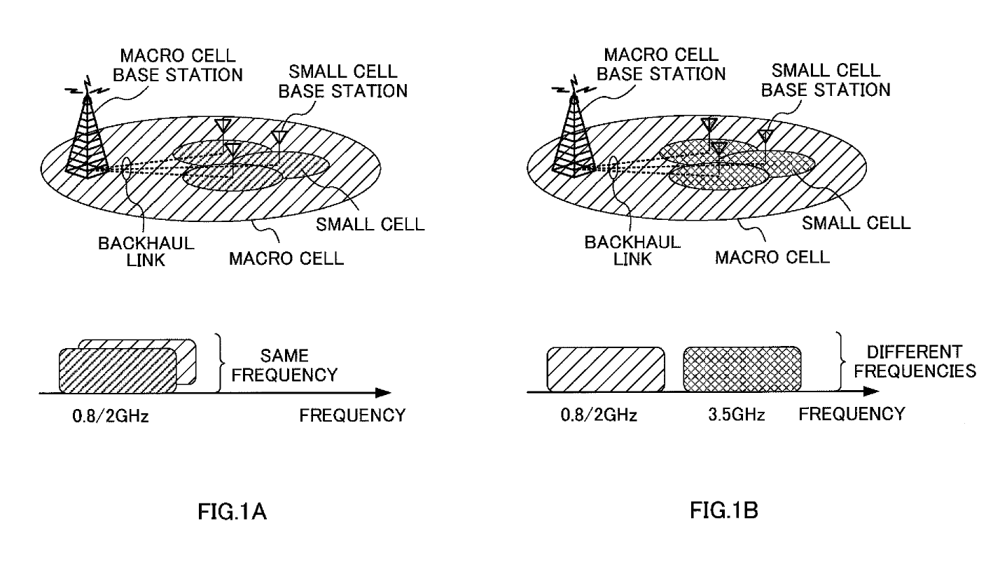

Now, an embodiment of the present invention will be described below in detail with reference to the accompanying drawings. FIG. 1 provides conceptual diagrams of a HetNet. FIG. 1A shows a case where the same frequency band is used between a macro cell and small cells. FIG. 1B shows a case where different frequency bands are used between a macro cell and small cells.

As shown in FIG. 1, a HetNet refers to a radio communication system in which a macro cell and small cells are placed overlapping each other geographically at least in part. Also, a HetNet is formed by including a radio base station that forms a macro cell (hereinafter referred to as a “macro cell base station”), a radio base station that forms a small cell (hereinafter referred to as a “small cell base station”), and a user terminal that communicates with the macro cell base station and the small cell base station.

In the case illustrated in FIG. 1A, it is possible to use, for example, carriers of the same frequency band such as 0.8 GHz (800 MHz) or 2 GHz in the macro cell and the small cells. In the case illustrated in FIG. 1B, for example, a carrier of a relatively low frequency band such as 0.8 GHz (800 MHz) or 2 GHz is used in the macro cell. Meanwhile, for example, a carrier of a relatively high frequency band such as 3.5 GHz is used in a plurality of small cells.

Also, when the small cells and the macro cell operate under different radio base stations, the macro cell base station and the small cell base stations are connected via backhaul links and exchange information mutually. The connection between the macro cell base station and the small cell base stations may assume wire connection by means of optical fiber, non-optical fiber (X2 interface) and so on, or may assume wireless connection. Note that, when the macro cell base station and the small cell base stations are connected via links other than optical fiber (for example, the X2 interface), the delay time in transmission/reception of information between the macro cell base station and the small cell base stations is not negligible. Ideally, the transmission delay of a backhaul is zero millisecond, but there is a possibility that the transmission delay becomes maximum several tens of milliseconds, depending on the environment of the backhaul.

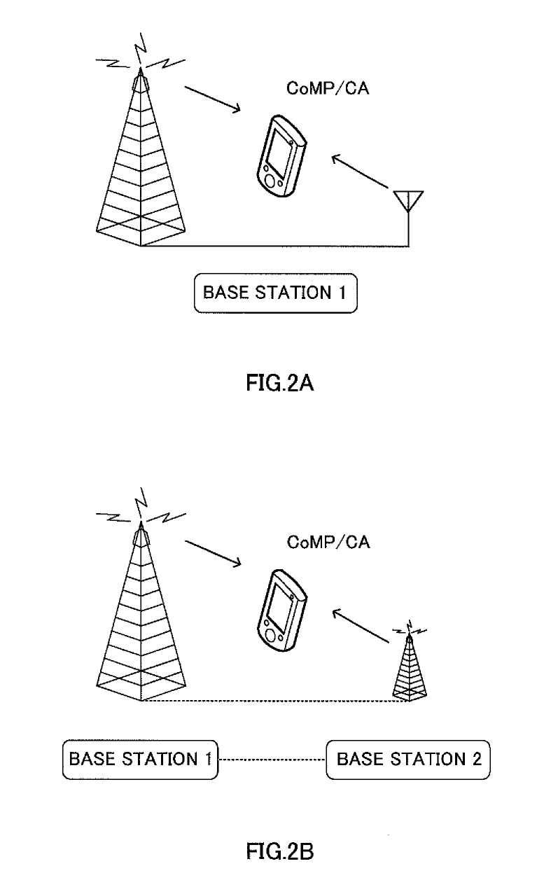

FIG. 2A is a conceptual diagram of intra-base station CoMP/CA. In intra-base station CoMP/CA, it is presumed that one base station (in FIG. 2A, the base station 1) controls the scheduling of two base stations.

FIG. 2B is a conceptual diagram of inter-base station CoMP/CA. In inter-base station CoMP/CA, it is presumed that two base stations (in FIG. 2B, the base stations 1 and 2) control scheduling separately. The base station 1 and the base station 2 are connected via a backhaul in which delay time is not negligible (non-ideal backhaul), and exchange information with each other.

In the inter-base station CoMP/CA shown in FIG. 2B, there is only one user terminal for two base stations. Consequently, there is a possibility that two base stations transmit downlink signals to a user terminal separately and simultaneously.

Also, in inter-base station CoMP/CA, there is a possibility that two base stations allocate uplink signal transmission to a user terminal separately and simultaneously. In this case, there is a threat that excess resources are allocated and cause a shortage of transmission power in the user terminal. Meanwhile, if control is executed so that the transmission power of the user terminals does not run short, there is a threat that the resources to allocate will run short.

The present invention will be described based on inter-base station CA. In inter-base station CA, a macro cell base station and a small cell base station communicate with a user terminal by using different frequency bands.

In conventional LTE and LTE-A systems, the uplink signal transmission power P_{PUSCH,c}(i) of a user terminal can be represented by the following equation 1:

P_{PUSCH,c}(i)=min{P_{CMAX,c}(i), 10log₁₀(M_{PUSCH,c}(i))+P_{O}_{_}_{PUSCH,c}(j)+α_{c}(j)□PL_{c}+Δ_{TF,c}(i)+f_{c}(i)} [dBm] (Equation 1),

Here, P_{CMAX,c}(i) is the maximum transmission power of the user terminal, M_{PUSCH,c}(i) is the number of PUSCH resource blocks, P_{O}_{_}_{PUSCH,c}(j) is a parameter that relates to transmission power offset and that is reported from the base station, α is a fractional TPC

(Transmission Power Control) slope parameter that is designated by the base station, PL_{c} is the propagation loss (path loss), Δ_{TF,c}(i) is a power offset value based on the modulation scheme and the coding rate, and f_{c}(i) is a correction value by a TPC command.

The user terminal determines the transmission power based on the above equation 1. When the transmission power reaches the maximum permissible transmission power, the user terminal adjusts the transmission power in accordance with predetermined priority.

The user terminal feeds back a PHR (Power Headroom Report) for reporting the user terminal's extra transmission power, to the base stations. The PHR is formed with a PH, which represents information about the difference between the user terminal's transmission power P_{PUSCH} and the maximum transmission power P_{CMAX}, and a two-bit reserved field.

As represented by the above equation 1, the user terminal's transmission power P_{PUSCH} is calculated based on the path loss PL_{c}, which is estimated from the downlink. The user terminal feeds back a PHR to the base stations when the fluctuation value of path loss is greater than a predetermined value. The base stations know the values of P_{CMAX,c}(i), M_{PUSCH,c}(i), P_{O}_{_}_{PUSCH,c}(j), α, Δ_{TF,c}(i) and f_{c}(i) in the equation 1, and therefore can determine the path loss PL_{c} by using the equation 1 upon acquiring the value of the PHR that is fed back.

The user terminal's extra transmission power PH_{type1,c}(i) can be represented by the following equation 2:

PH_{type1,c}(i)=P_{CMAX,c}(i)−{10log₁₀(M_{PUSCH,c}(i))+P_{O}_{_}_{PUSCH,c}(j)+α_{c}(j)□PL_{c}+Δ_{TF,c}(i)+f_{c}(i)} [dBm] (Equation 2),

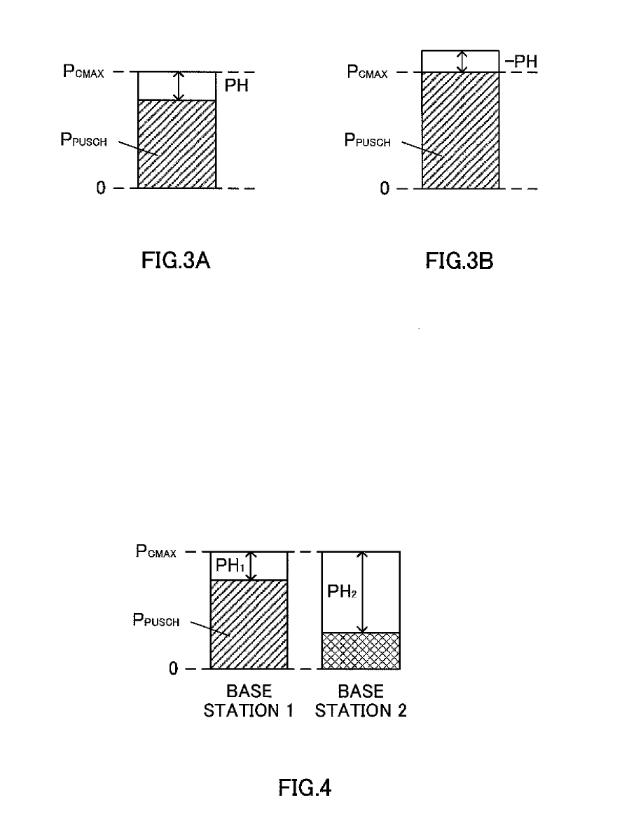

FIG. 3 is a conceptual diagram to explain the user terminal's extra transmission power PH. As shown in FIG. 3A, when the user terminal's transmission power P_{PUSCH} does not reach the maximum transmission power P_{CMAX}, the value given by subtracting the transmission power P_{PUSCH} from the maximum transmission power P_{CMAX} is reported as the value of extra transmission power PH.

As shown in FIG. 3B, when the user terminal's transmission power P_{PUSCH} reaches the maximum transmission power P_{CMAX}, the actual transmission power is reported as the value of the maximum transmission power P_{CMAX}, and, for the value of extra transmission power PH, a negative value is reported based on the above equation 2.

When the above-described TPC control and PHR control are applied to inter-base station CA, provided that MAC schedulers and TPC control are provided separately between CCs, each base station is unable to know the condition of transmission power in the user terminal completely.

That is to say, the base stations cannot know the values of the number of resource blocks M_{PUSCH,c}(i), the path loss PL_{c}, the power offset value Δ_{TF,c}(i) based on the modulation scheme and the coding rate and the correction value by a TPC command f_{c}(i) in the above equation 1. These values are unknown variables to the base stations.

Even when a PHR is fed back from the user terminal, a base station does not know the variables that have been used to calculate the user terminal's extra transmission power PH with respect to a cell operated under another base station, and therefore cannot estimate the path loss PL_{c}.

FIG. 4 is a conceptual diagram to explain the extra transmission power PH which the user terminal shown in FIG. 2B feeds back. PH₁ in FIG. 4 represents the value of extra transmission power with respect to the cell operated under the base station 1 in FIG. 2B. PH₂ in FIG. 4 represents the value of extra transmission power with respect to the cell operated under the base station 2 in FIG. 2B.

The present inventors have arrived at allowing radio base stations to execute transmission power control, when inter-base station CA is employed, by detecting when the transmission power of a user terminal reaches the maximum transmission power, and executing control to cancel this.

To be more specific, when radio base stations detect that the transmission power of a user terminal has reached the maximum transmission power, the radio base stations execute adequate uplink resource allocation, transmission power control and so on.

Now, the power scaling rules provided for execution of transmission power control will be described below in detail.

### First Embodiment

A method will be described with a first embodiment whereby a user terminal reports to radio base stations that the transmission power of the subject terminal has reached the maximum transmission power—that is, that the subject terminal is in a power-limited state.

When the PH for a given cell or CC, calculated based on the equation 1, becomes 0 or a negative value, the user terminal reports a PHR, in a MAC header, to the radio base stations having allocated uplink resources. Here, the case where PH becomes 0 or a negative value or the case where PH becomes 0 or less refers to the case where the value of the second term in the right clause of the equation 1, namely {10log₁₀(M_{PUSCH,c}(i))+P_{O}_{_}_{PUSCH,c}(j)+α_{c}(j)□PL_{c}+Δ_{TF,c}(i)+f_{c}(i)}, becomes the same as or greater than the value of the first term in the right clause, namely P_{CMAX,c}(i).

In LTE Rel. 11 or earlier versions, PHRs from user terminals as supported are only timer-based periodic reports and reports that are sent when path loss changes beyond a threshold.

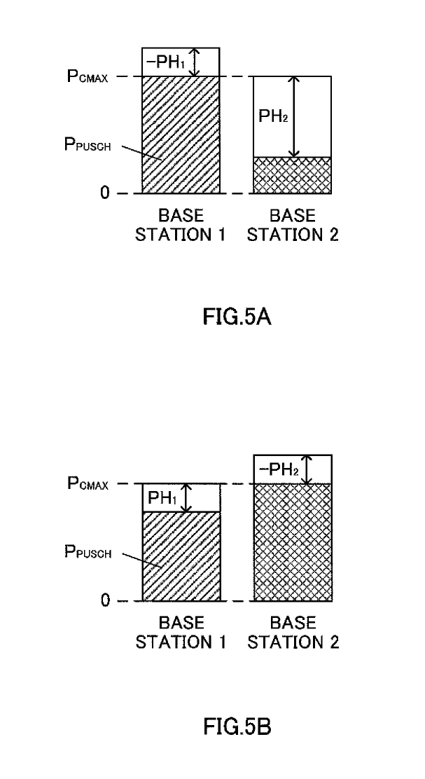

With the present embodiment, a user terminal is triggered to report a PHR to radio base stations when PH becomes 0 or less. For example, in FIG. 5A, PH₁ for the cell (CC) which the base station 1 operates assumes a negative value, and therefore the user terminal feeds back a PHR to the base stations 1 and 2. In FIG. 5B, PH₂ for the cell (CC) which the base station 2 operates assumes a negative value, and therefore the user terminal feeds back a PHR to the base stations 1 and 2.

By this means, the radio base stations having allocated uplink resources can quickly detect that the user terminal is in a power-limited state.

The range of PH which can be reported in a PHR is limited to a volume of six bits. Although the regular PH range is from −23 [dB] to +40 [dB], among PHRs that are reported according to the present example, at least one PH always has a negative value, so that the specific PH range never assumes values between 0 [dB] and +40 [dB].

So, when the user terminal's transmission power reaches the maximum transmission power, and, triggered by this, a PHR is reported, it is possible to change the range of the PH. The specific PH range may be, for example, −63 [dB] to 0 [dB]. By changing the range of the specific PH, even when transmission power to exceed the user terminal's maximum transmission power substantially is allocated, it is still possible to adequately report the excess power with a PH of a negative value.

Now, there is a threat that base stations cannot distinguish between a “regular PH,” which ranges from −23 [dB] to +40 [dB], and a “specific PH,” which ranges from −63 [dB] to 0 [dB].

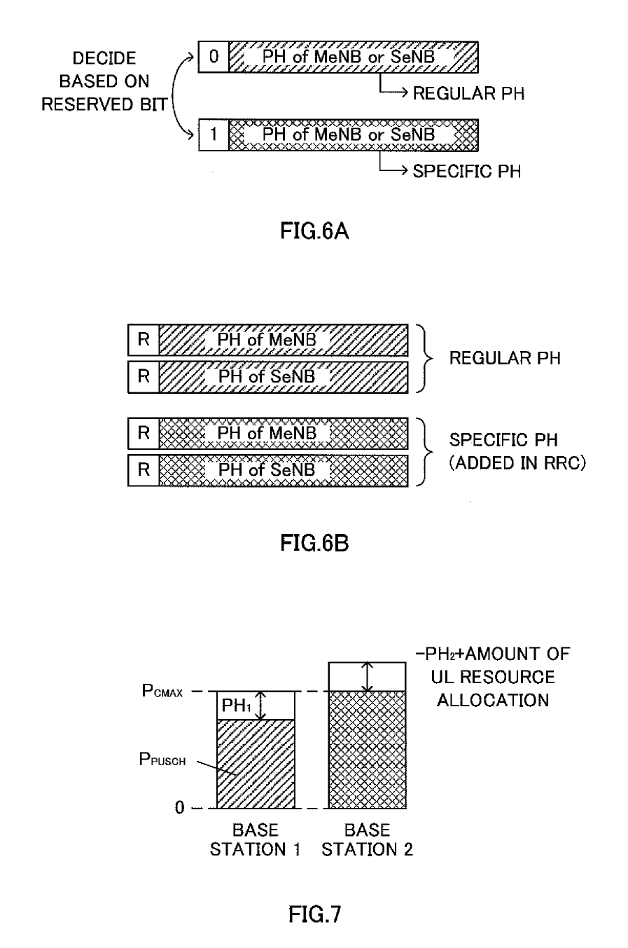

As shown in FIG. 6A, if the reserved bit, which has been “0” up to Rel. 11 is made “1,” the PH included in the PHR may be judged a specific PH. In this case, by distinguishing between a regular PH and a specific PH, radio base stations can accurately learn how much the transmission power in a user terminal in a power-limited state exceeds the maximum transmission power.

Also, since existing reserved bits are used, the overhead does not increase.

The use of existing reserved bits has a minimal impact on the specifications.

As shown in FIG. 6B, radio base stations may report whether the type of the PHR field is a regular PH or a specific PH, through RRC signaling. In this case, no reserved bit is used.

To be more specific, when radio base stations configure reporting regular PHs and specific PHs through higher layer such as RRC, the configuration may include showing which elements among the information elements constituting the MAC header are regular PHs and which elements are specific PHs.

By distinguishing between regular PHs and specific PHs, radio base stations can accurately learn how much the transmission power in a user terminal in a power-limited state exceeds the maximum transmission power. Furthermore, the use of existing PHR fields has a minimal impact on the specifications.

For example, conventional intra-base station CA provides a mechanism for reporting regular PHs for multiple CCs in the MAC header together. In this case, a plurality of PHs are included in the MAC header. So, rather than reporting regular PHs for multiple CCs all at once, appropriating these information elements to report regular PHs and specific PHs instead makes it possible to report specific PHs, while maintaining the user terminal operation and the radio interface in the same mechanism as in intra-base station CA.

As for the reasons that a user terminal enters a power-limited state, first, excess power is allocated due to a shortage of transmission power, and, second, excess uplink resources are allocated because of a large volume of transmission data.

In the first case—that is, when excess power is allocated due to a shortage of transmission power—giving power to radio base stations where the transmission power has not reached the maximum value enables quicker data processing. This is because a shortage of power means a low SINR (Signal-to-Interference plus Noise power Ratio) and poor quality.

In the second case—that is, when excess uplink resources are allocated—giving power to radio base stations where the transmission power has reached the maximum value enables quicker data processing. This is because allocation of excess uplink resources means that there is a large volume of data to transmit.

Radio base stations cannot identify the reason a user terminal is in a power-limited state from the PHRs fed back from the user terminal. That is, radio base stations have no way of knowing whether a user terminal is in a power-limited state for the above first reason or for the above second reason.

So, when the value of a specific PH is reported in a PHR, it is possible to report the volume of uplink resource allocation, together with the PH, in the MAC header. For example, if the volume of uplink resource allocation uses six bits as PH does, this can be reported in a resolution of 64 values.

In FIG. 7, PH₂ for the cell (CC) which the base station 2 operates is a negative value. That is, the transmission power of the base station 2 has reached the maximum value. The user terminal reports the value of PH₂ and the volume of uplink resource allocation to the base station 2 using a PHR. In this case, the base stations 1 and 2 can know whether the reason the user terminal enters a power-limited state is the above first reason or the above second reason. Consequently, the base stations 1 and 2 are able to execute transmission power control that is suitable for each of the above-described reasons.

The user terminal may report the volume of uplink resource allocation not only with respect to the base station where the PH shows a negative value, but also with respect to both base stations. In the example shown in FIG. 7, the volume of uplink resource allocation may be reported not only with respect to the base station 2, but also with respect to the base station 1 as well, in addition to the PH value. By this means, the base station where the PH shows a negative value (in FIG. 7, the base station 2) can know the volume of uplink resource allocation in the other base station (in FIG. 7, the base station 1).

The volume of uplink resource allocation may be reported by appropriating the MAC header field that has been introduced for the PHRs in CA.

When the user terminal reports both the value of a specific PH and the volume of uplink resource allocation (hereinafter also referred to as a “specific report”), or one of these, this report may be, like uplink control information (UCI), multiplexed over PUSCH data and transmitted, not in the MAC header. In this case, a regular PHR is reported in the MAC header and a specific report is multiplexed over PUSCH data, so that radio base stations can distinguish between the regular PH and the specific PH.

The user terminal may transmit a specific report to both the MeNB (Master eNB) and the SeNB (Secondary eNB), or may report a specific report to the MeNB alone. When the user terminal transmits a specific report to the MeNB alone, high throughput can be maintained by maintaining power with respect to the SeNB that carries out high-capacity communication, and by carrying out transmission power control for the MeNB for the power that is short. In other words, the user terminal is able to operate so that, in order to maintain high throughput, transmission power is preferentially secured for the SeNB that carries out high capacity communication.

The user terminal may transmit a specific report to the SeNB alone. In this case, the user terminal can prevent the increase of the call loss rate by maintaining power with respect to the MeNB, which communicates control information, and by carrying out transmission power control for the SeNB, which communicates data alone, for the power that is short. In other words, the user terminal is able to operate so that, in order to maintain the quality of communication high, transmission power is preferentially secured for the MeNB that communicates control information.

The user terminal may report the volume of uplink resource allocation alone in a specific report. That is, when the value of PH is 0 or less, the user terminal reports the volume of uplink resource allocation. In this case, the radio base stations will learn that receiving a specific report from the user terminal is in itself an indication that the value of PH is 0 or less. By this means, the radio base stations can know, with low overhead, that the user terminal is in a power-limited state, and know the volume of uplink resource allocation then. By knowing the volume of data, the radio base stations can adjust transmission power adequately.

The user terminal may include and transmit a buffer status report (BSR) in a specific report. In this case, the radio base stations can select a radio base station to which power should be appropriated preferentially, based on the BSR, with reference to the volume of uplink data which the user terminal carries.

Next, with reference to the first embodiment, an example of the operation when a user terminal reports to radio base stations that the subject terminal is in a power-limited state will be described.

The MeNB configures a SeNB for the user terminal through RRC signaling and so on, and starts inter-base station CA. In RRC control information, both a specific PH and the volume of uplink resource allocation, or one of these, and also a regular PH report, are configured.

The MeNB and the SeNB each transmit an uplink grant to the user terminal. The uplink grants include TPC commands, whereby transmission power control is carried out.

The user terminal transmits uplink data to the MeNB and the SeNB in accordance with the uplink grants. The user terminal includes and transmits regular PHs in the MAC header in accordance with the timer, changes in path loss and so on. When the value of PH becomes 0 or less in either CC, the user terminal includes and transmits both a specific PH and the volume of uplink resource allocation, or one of these, in the MAC header or in the PUSCH.

When both the specific PH and the volume of uplink resource allocation are reported or when one of these is reported, the radio base stations adjust transmission power so as to cancel the user terminal's power-limited state. The user terminal may assume a power-limited state in three patterns—namely, when the PH of the subject base station is positive and the PH of the other base station is 0 or less, when the PH of the subject base station is 0 or less and the PH of the other base station is positive, and when the PH of the subject base station and the PH of the other base station are both 0 or less. The radio base stations carry out adequate transmission power adjustment with reference to the PHs, the volume of uplink resource allocation, the BSR and so on reported from the user terminal.

### Second Embodiment

A method will be described with a second embodiment whereby the network detects when the transmission power of a user terminal reaches the maximum transmission power.

The network (radio base stations) detects when a user terminal is in a power-limited state, from the uplink data error rate, the number of HARQ (Hybrid Automatic Repeat Request) retransmissions, and so on. When a user terminal is in a power-limited state, the user terminal oftentimes transmits uplink data before or without reaching the required transmission power which the radio base stations demand. As a result, for example, the uplink data error rate and the number of HARQ retransmissions increase.

Based on the uplink data error rate, the number of HARQ retransmissions and so on, the radio base stations detect when the user terminal is in a power-limited state, and execute transmission power control. In this case, it is not necessary to change the specifications, so that it is possible to implement the transmission power control by the radio base stations without increasing the circuit scale of the user terminal.

Information about the error rate, the number of HARQ retransmissions, the throughput and so on with respect to each radio base station may be reported from the user terminal to the radio base stations. For example, the user terminal may report the average number of retransmissions and average throughput per CC, to the radio base stations.

When a radio base station commands an increase of transmission power with a TPC command and yet the quality does not improve, the user terminal is likely to be in a power-limited state. In this case, the radio base station can cancel the user terminal's power-limited state by commanding a decrease of transmission power.

When a radio base station commands an increase of transmission power with a TPC command and the quality improves, the user terminal is likely to be running short of transmission power. In this case, the radio base station can improve the deterioration of the quality of uplink data transmission by the user terminal by commanding an increase of transmission power.

By this means, the radio base stations can detect when transmission power runs short, in addition to detecting when the user terminal is in a power-limited state.

The user terminal may transmit information about each CC's average number of retransmissions, average throughput and so on, in the MAC header, as in a PHR, or may multiplex and transmit these pieces of information over the PUSCH like UCI. By this means, it is possible to transmit these pieces of information with low overhead.

### Third Embodiment

A method will be described with a third embodiment whereby a user terminal reports to radio base stations whether or not the subject terminal is in a power-limited state.

As noted earlier, the values of the number of resource blocks M_{PUSCH,c}(i), the path loss PL_{c}, the power offset value Δ_{TF,c}(i) based on the modulation scheme and the coding rate and the correction value by a TPC command f_{c}(i) in the above equation 1 are unknown variables to radio base stations.

Among these unknown variables, the values of the path loss PL_{c}, the power offset value Δ_{TF,c}(i) based on the modulation scheme and the coding rate and the correction value by a TPC command f_{c}(i) are likely to vary little, and in a comparatively moderate manner. Consequently, these variables, even if unknown to radio base stations, have little impact on transmission power control.

On the other hand, if the number of resource blocks M_{PUSCH,c}(i) is not known in radio base stations, this has a more significant impact on transmission power control. The transmission power of other CCs fluctuates significantly depending on the scheduling of the other CCs (the number of resource blocks). The condition of power that is learned from existing PHR is too old, and therefore it is necessary to learn the condition of power dynamically, by using other methods.

The user terminal can dynamically report to radio base stations whether or not the subject terminal is in a power-limited state, by using the PUSCH or the PUCCH. That is, radio base stations can learn, dynamically, whether or not the user terminal is in a power-limited state.

Whether or not the user terminal is in a power-limited state can be reported, by way of signaling, by adding one bit to the PUSCH or the PUCCH. For example, it is possible to provide that the bit “0” indicates not being in a power-limited state and “1” indicates being in a power-limited state.

Although the above method allows a radio base station to learn whether or not the user terminal is in a power-limited state, the radio base station nevertheless is unable to know whether the reason originates from the subject cell (the subject base station) or originates from other cells (other base stations).

So, in the dynamic signaling by the user terminal, it is possible to add more bits and report the subject cell's power as well. For example, it is possible to provide that the bits “00” represent that there is not a power-limited state, “01” represents that there is a power-limited state and the subject cell's power occupancy ratio is lower than a reference value, “10” represents that there is a power-limited state and the subject cell's power occupancy ratio is higher than a reference value, and “11” represents “reserved.”

That is to say, when the bits “10” are attached, the radio base station understands that the transmission power of the subject cell needs to be lowered. The reference value for judging whether the power occupancy ratio in the subject cell is high or low may be designated by RRC or by the MAC layer, or equal distribution may be applied between cells. The power occupancy ratio is not a simple ratio, and it is also possible to report whether or not there is extra remaining power after the minimum required resources are allocated to the other cells.

### Structure of Radio Communication System

Now, the structure of the radio communication system according to the present embodiment will be described below. In this radio communication system, the above-described radio communication methods according to the first to third embodimetns are employed.

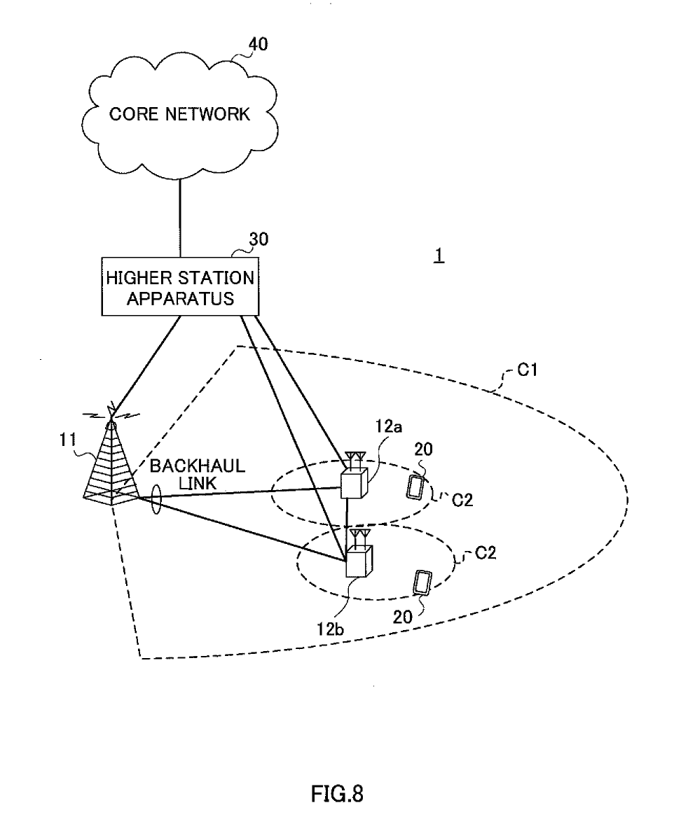

FIG. 8 is a schematic structure diagram to show an example of the radio communication system according to the present embodiment. As shown in FIG. 8, the radio communication system 1 has a macro base station 11 that forms a macro cell C1, and small base stations 12a and 12b that are placed in the macro cell C1 and that form small cells C2, which are narrower than the macro cell C1. In FIG. 8, the user terminals 20, provided as radio communication terminals, are structured to be capable of carrying out radio communication with at least one of the macro base station 11 and the small base station 12a and 12b (hereinafter collectively referred to as “small base stations 12”). Note that the numbers of the macro base station 11 and the small base stations 12 are not limited to those illustrated in FIG. 8.

In the macro cell C1 and the small cells C2, the same frequency band may be used, or different frequency bands may be used. Also, the macro base station 11 and each small base station 12 are connected with each other via an inter-base station interface (for example, optical fiber, X2 interface, etc.). The macro base station 11 and the small base station 12 are each connected with a higher station apparatus 30, and are connected to a core network 40 via the higher station apparatus 30. Note that the higher station apparatus 30 may be, for example, an access gateway apparatus, a radio network controller (RNC), a mobility management entity (MME) and so on, but is by no means limited to these.

Note that the macro base station 11 is a radio base station having a relatively wide coverage, and may be referred to as an “eNodeB (eNB),” a “radio base station,” a “transmission point” and so on. The small base stations 12 are radio base stations having local coverages, and may be referred to as “RRHs (Remote Radio Heads),” “pico base stations,” “femto base stations,” “HeNBs (Home eNodeBs),” “transmission points,” “eNodeBs (eNBs)” and so on. The user terminals 20 are terminals to support various communication schemes such as LTE and LTE-A, and may not only be mobile communication terminals, but may also be stationary communication terminals as well.

The radio communication system 1 presumes the case where the networks that are formed per macro cell are asynchronous (asynchronous operation). In the radio communication system 1, as radio access schemes, OFDMA (Orthogonal Frequency Division Multiple Access) is applied to the downlink, and SC-FDMA (Single-Carrier Frequency Division Multiple Access) is applied to the uplink.

Also, in the radio communication system 1, a downlink shared channel (PDSCH: Physical Downlink Shared Channel), which is used by each user terminal 20 on a shared basis, a downlink control channel (PDCCH: Physical Downlink Control Channel), an EPDCCH (Enhanced Physical Downlink Control Channel), a PCFICH (Physical Control Format Indicator Channel), a PHICH (Physical Hybrid-ARQ Indicator Channel), a broadcast channel (PBCH: Physical Broadcast Channel) and so on are used as downlink communication channels. User data and higher layer control information are transmitted by the PDSCH. Downlink control information (DCI) is transmitted using the PDCCH and/or the EPDCCH.

Also, in the radio communication system 1, an uplink shared channel (PUSCH: Physical Uplink Shared Channel), which is used by each user terminal 20 on a shared basis, an uplink control channel (PUCCH: Physical Uplink control Channel) and so on are used as uplink communication channels. User data and higher layer control information are transmitted by the PUSCH. Also, by the PUCCH, downlink radio quality information (CQI: Channel Quality Indicator), delivery acknowledgement information (ACK/NACK) and so on are transmitted.

Hereinafter, the macro base station 11 and the small base stations 12 will be collectively referred to as “radio base station 10” unless specified otherwise.

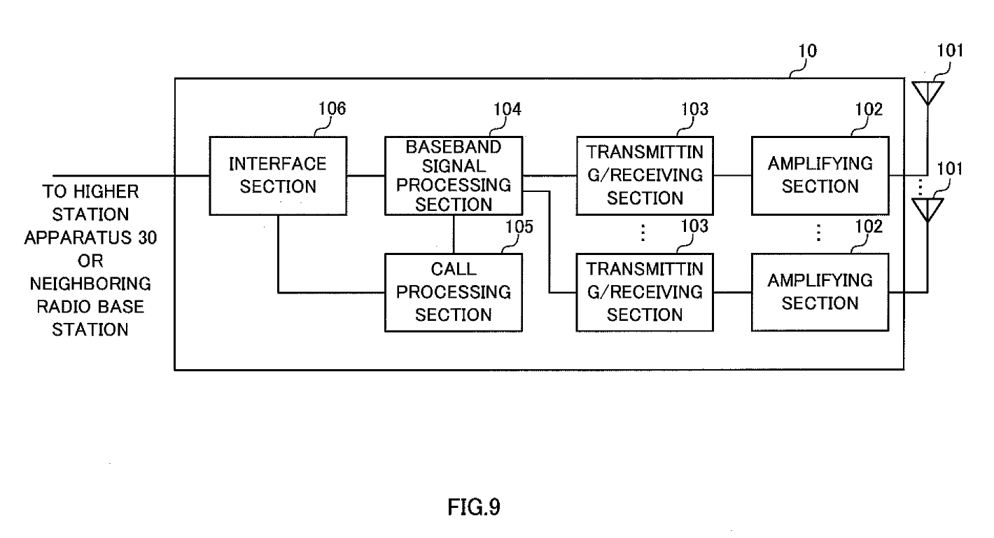

FIG. 9 is a diagram to explain an overall structure of a radio base station 10 according to the present embodiment. The radio base station 10 has a plurality of transmitting/receiving antennas 101 for MIMO transmission, amplifying sections 102, transmitting/receiving sections 103, a baseband signal processing section 104, a call processing section 105 and an interface section 106.

User data to be transmitted from the radio base station 10 to a user terminal 20 on the downlink is input from the higher station apparatus 30, into the baseband signal processing section 104, via the interface section 106.

In the baseband signal processing section 104, a PDCP layer process, division and coupling of the user data, RLC (Radio Link control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a pre-coding process are performed, and the result is transferred to each transmitting/receiving section 103. Furthermore, downlink control signals are also subjected to transmission processes such as channel coding and an inverse fast Fourier transform, and are transferred to each transmitting/receiving section 103.

Each transmitting/receiving section 103 converts the downlink signals, which are pre-coded and output from the baseband signal processing section 104 on a per antenna basis, into a radio frequency band. The amplifying sections 102 amplify the radio frequency signals having been subjected to frequency conversion, and the results are transmitted through the transmitting/receiving antennas 101.

On the other hand, as for uplink signals, radio frequency signals that are received in the transmitting/receiving antennas 101 are each amplified in the amplifying sections 102, converted into baseband signals through frequency conversion in each transmitting/receiving section 103, and input in the baseband signal processing section 104.

In the baseband signal processing section 104, the user data that is included in the input uplink signals is subjected to an FFT process, an IDFT process, error correction decoding, a MAC retransmission control receiving process, and RLC layer and PDCP layer receiving processes, and the result is transferred to the higher station apparatus 30 via the interface section 106. The call processing section 105 performs call processing such as setting up and releasing communication channels, manages the state of the radio base station 10 and manages the radio resources.

The interface section 106 transmits and receives signals to and from neighboring radio base stations (backhaul signaling) via an inter-base station interface (for example, optical fiber, X2 interface, etc.). Alternatively, the interface section 106 transmits and receives signals to and from the higher station apparatus 30 via a predetermined interface.

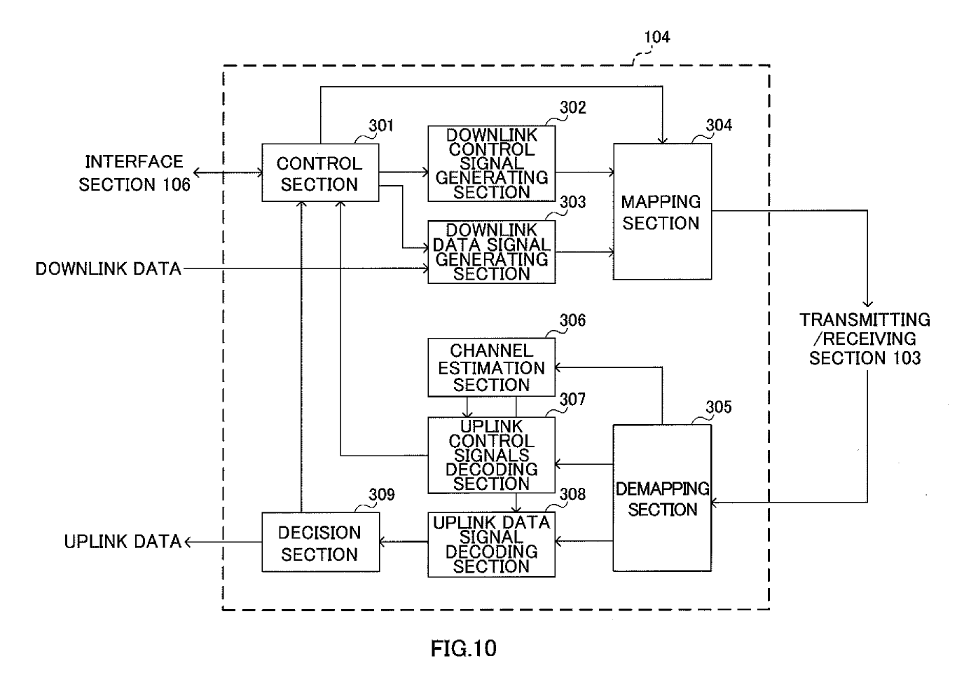

FIG. 10 is a diagram to show a principle functional structure of the baseband signal processing section 104 provided in the radio base station 10 according to the present embodiment. As shown in FIG. 10, the baseband signal processing section 104 provided in the radio base station 10 is comprised at least of a control section 301, a downlink control signal generating section 302, a downlink data signal generating section 303, a mapping section 304, a demapping section 305, a channel estimation section 306, an uplink control signal decoding section 307, an uplink data signal decoding section 308 and a decision section 309.

The control section 301 controls the scheduling of downlink user data that is transmitted in the PDSCH, downlink control information that is transmitted in one or both of the PDCCH and the enhanced PDCCH (EPDCCH), downlink reference signals and so on. Also, the control section 301 also controls the scheduling of RA preambles transmitted in the PRACH, uplink data that is transmitted in the PUSCH, uplink control information that is transmitted in the PUCCH or the PUSCH, and uplink reference signals (allocation control). Information about the allocation control of uplink signals (uplink control signals, uplink user data, etc.) is reported to the user terminal 20 by using a downlink control signal (DCI).

The control section 301 controls the allocation of radio resources to downlink signals and uplink signals based on command information from the higher station apparatus 30, feedback information from each user terminal 20, and so on. That is, the control section 301 functions as a scheduler.

The control section 301 learns whether or not the user terminal 20 is in a power-limited state, based on PHRs, the volume of uplink resource allocation and so on that are reported from the user terminal 20, and executes adequate power control when the user terminal 20 is in a power-limited state. Alternatively, the control section 301 detects whether or not the user terminal 20 is in a power-limited state based on the uplink data error rate, the number of HARQ retransmissions and so on.

The downlink control signal generating section 302 generates downlink control signals (which may be both PDCCH signals and EPDCCH signals, or may be one of these) that are determined to be allocated by the control section 301. To be more specific, the downlink control signal generating section 302 generates a DL assignment, which reports downlink signal allocation information, and a UL grant, which reports uplink signal allocation information, based on commands from the control section 301.

The downlink data signal generating section 303 generates downlink data signals (PDSCH signals) that are determined to be allocated to resources by the control section 301. The data signals that are generated in the downlink data signal generating section 303 are subjected to a coding process and a modulation process, based on the coding rates and modulation schemes that are determined based on the CSI from each user terminal 20 and so on.

The mapping section 304 controls the allocation of the downlink control signals generated in the downlink control signal generating section 302 and the downlink data signals generated in the downlink data signal generating section 303 to radio resources based on commands from the control section 301.

The demapping section 305 demaps an uplink signal transmitted from the user terminal 20 and separates the uplink signal. The channel estimation section 306 estimates the channel state from the reference signals included in the received signal separated in the demapping section 305, and outputs the estimated channel state to the uplink control signal decoding section 307 and the uplink data signal decoding section 308.

The uplink control signal decoding section 307 decodes the feedback signal (delivery acknowledgement signal and/or the like) transmitted from the user terminal in the uplink control channel (PRACH, PUCCH, etc.), and outputs the result to the control section 301. The uplink data signal decoding section 308 decodes the uplink data signal transmitted from the user terminal in the uplink shared channel (PUCCH), and outputs the result to the decision section 309. The decision section 309 makes a retransmission control decision (A/N decision) based on the decoding result in the uplink data signal decoding section 308, and outputs the result to the control section 301.

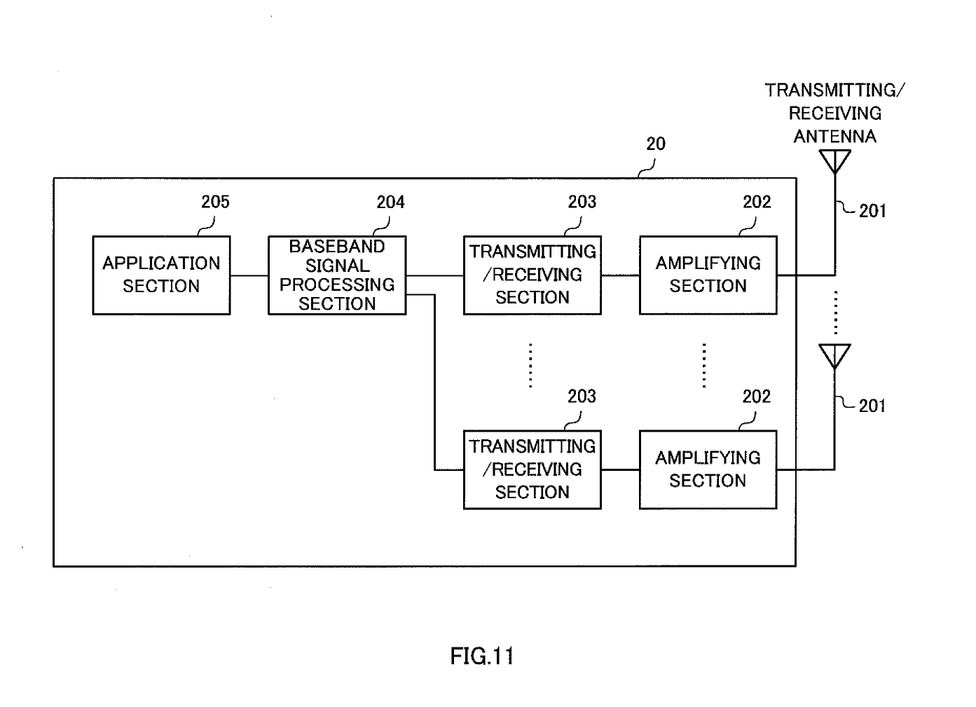

FIG. 11 is a diagram to show an overall structure of the user terminal 20 according to the present embodiment. As shown in FIG. 11, the user terminal 20 has a plurality of transmitting/receiving antennas 201 for MIMO transmission, amplifying sections 202, transmitting/receiving sections (receiving sections) 203, a baseband signal processing section 204 and an application section 205.

As for downlink data, radio frequency signals that are received in a plurality of transmitting/receiving antennas 201 are each amplified in the amplifying sections 202, subjected to frequency conversion in the transmitting/receiving sections 203, and converted into the baseband signal. This baseband signal is subjected to an FFT process, error correction decoding, a retransmission control receiving process and so on in the baseband signal processing section 204. In this downlink data, downlink user data is transferred to the application section 205. The application section 205 performs processes related to higher layers above the physical layer and the MAC layer. Furthermore, in the downlink data, broadcast information is also transferred to the application section 205.

Meanwhile, uplink user data is input from the application section 205 into the baseband signal processing section 204. In the baseband signal processing section 204, a retransmission control (HARQ: Hybrid ARQ) transmission process, channel coding, precoding, a DFT process, an IFFT process and so on are performed, and the result is transferred to each transmitting/receiving section 203. The baseband signal that is output from the baseband signal processing section 204 is converted into a radio frequency band in the transmitting/receiving sections 203. After that, the amplifying sections 202 amplify the radio frequency signal having been subjected to frequency conversion, and the result is transmitted from the transmitting/receiving antennas 201.

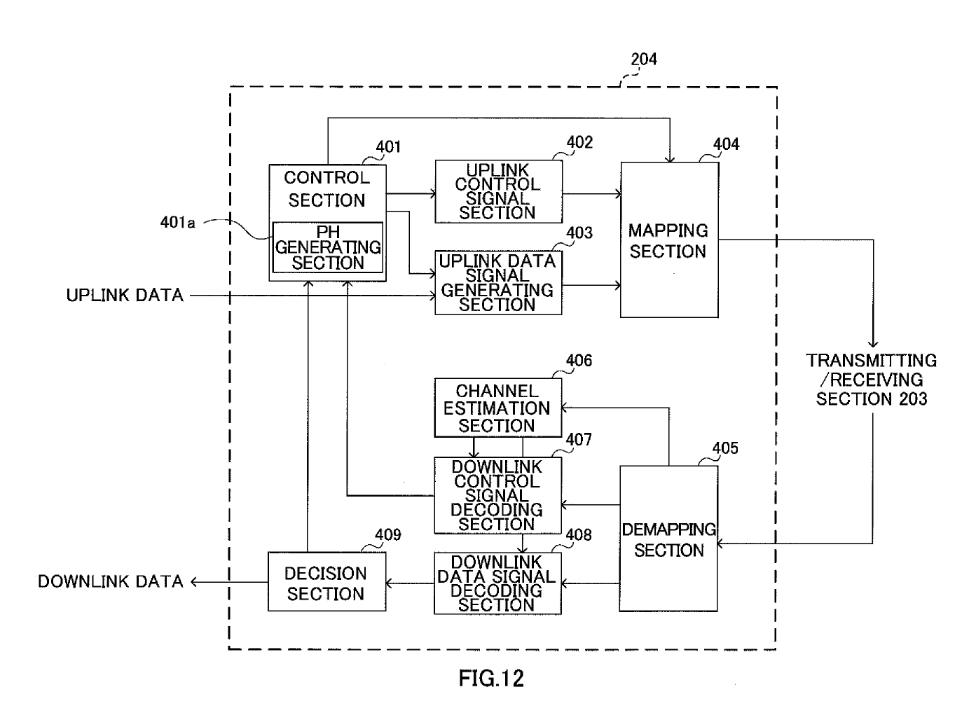

FIG. 12 is a diagram to show a principle functional structure of the baseband signal processing section 204 provided in the user terminal 20. As shown in FIG. 12, the baseband signal processing section 204 provided in the user terminal 20 is comprised at least of a control section 401, an uplink control signal generating section 402, an uplink data signal generating section 403, a mapping section 404, a demapping section 405, a channel estimation section 406, a downlink control signal decoding section 407, a downlink data signal decoding section 408 and a decision section 409.

The control section 401 controls the generation of uplink control signals (A/N signals, etc.), uplink data signals and so on based on downlink control signals (PDCCH signals) transmitted from the radio base station, retransmission control decisions in response to the PDSCH signals received, and so on. The downlink control signals received from the radio base station are output from the downlink control signal decoding section 407, and the retransmission control decision is output from the decision section 409.

The control section 401 has a PH generating section 401a. The PH generating section 401 a calculates the transmission power of uplink signals based on the maximum transmission power of the user terminal 20, a parameter that represents the number of PUSCH resource blocks, that relates to transmission power offset and that is reported from the radio base station 10, a power offset value that represents a fractional TPC slope parameter designated by the radio base station and that is based on the path loss, the modulation scheme and the coding rate, and a correction value by a TPC command. The PH generating section 401a calculates PH, which represents information about the difference between the transmission power of the user terminal 20 and the maximum transmission power.

The control section 401 executes control so that, when the value of PH becomes 0 or less, the PH is triggered and reported to the radio base station 10. The control section 401 may execute control so that the volume of uplink resource allocation is reported to the radio base station 10 with the PH. The control section 401 may also execute control so that the volume of uplink resource allocation alone is reported to the radio base station 10, without reporting the PH. The control section 401 may execute control so that a specific report is sent to one or both of the MeNB and the SeNB.

The uplink control signal generating section 402 generates uplink control signals (feedback signals such as delivery acknowledgement signals, channel state information (CSI) and so on) based on commands from the control section 401. The uplink data signal generating section 403 generates uplink data signals based on commands from the control section 401. Note that, when an uplink grant is contained in a downlink control signal reported from the radio base station, the control section 401 commands the uplink data signal generating section 403 to generate an uplink data signal.

The mapping section 404 controls the allocation of the uplink control signals (delivery acknowledgment signals and so on) and the uplink data signals to radio resources (PUCCH, PUSCH, etc.) based on commands from the control section 401.

The demapping section 406 demaps a downlink signal transmitted from the radio base station 10 and separates the downlink signal. The channel estimation section 407 estimates the channel state from the reference signals included in the received signal separated in the demapping section 405, and outputs the estimated channel state to the downlink control signal decoding section 407 and the downlink data signal decoding section 408.

The downlink control signal decoding section 407 decodes the downlink control signal (PDCCH signal) transmitted in the downlink control channel (PDCCH), and outputs the scheduling information (information regarding the allocation to uplink resources) to the control section 401. Also, when the downlink control signal includes information related to the cells where delivery acknowledgement signals are fed back, information as to whether or not to apply RF adjustment and so on, these pieces of information are also output to the control section 401.

The downlink data signal decoding section 408 decodes the downlink data signal transmitted in the downlink shared channel (PDSCH), and outputs the result to the decision section 409. The decision section 409 makes a retransmission control decision (A/N decision) based on the decoding result in the downlink data signal decoding section 408, and outputs the result to the control section 401.

The present invention is by no means limited to the above embodiment and can be implemented in various modifications. The sizes and shapes illustrated in the accompanying drawings in relationship to the above embodiment are by no means limiting, and may be changed as appropriate within the scope of optimizing the effects of the present invention. Besides, implementations with various appropriate changes may be possible without departing from the scope of the object of the present invention.

The disclosure of Japanese Patent Application No. 2013-200400, filed on Sep. 26, 2013, including the specification, drawings and abstract, is incorporated herein by reference in its entirety.

1. A user terminal that communicates by applying carrier aggregation in which a plurality of radio base stations, connected via non-ideal backhauls, are each made a component carrier, the user terminal comprising:
a transmission section that transmits an uplink physical channel to each component carrier;
a power headroom generating section that generates power headroom which is extra transmission power of the user terminal; and
a control section that, when a value of the power headroom becomes 0 or less, executes control so that the power headroom is triggered and reported to the radio base stations.

2. The user terminal according to claim 1, wherein, when the value of the power headroom becomes 0 or less, the power headroom generating section is triggered to make a range of the power headroom to be reported −63 [dB] to 0 [dB].

3. The user terminal according to claim 2, wherein the control section makes a value of a reserved bit included in the power headroom “1.”

4. The user terminal according to claim 2, wherein the power headroom is reported via RRC signaling.

5. The user terminal according to claim 1, wherein the control section executes control so that, with the power headroom, a volume of uplink resource allocation is also reported to the radio base stations.

6. The user terminal according to claim 1, wherein the control section executes control so that, when the value of the power headroom becomes 0 or less, a volume of uplink resource allocation alone is triggered and reported to the radio base stations.

7. The user terminal according to claim 1, wherein the control section executes control so that the power headroom is reported to a master base station (MeNB) alone.

8. The user terminal according to claim 1, wherein the control section executes control so that the power headroom is reported to a secondary base station (SeNB) alone.

9. The user terminal according to claim 1, wherein the control section executes control so that, with the power headroom, a buffer status report is also reported.

10. A radio communication method for a user terminal that communicates by applying carrier aggregation, in which a plurality of radio base stations, connected via non-ideal backhauls, are each made a component carrier, the radio communication method comprising the steps of:
transmitting an uplink physical channel to each component carrier;
generating power headroom which is extra transmission power of the user terminal; and
when a value of the power headroom becomes 0 or less, executing control so that the power headroom is triggered and reported to the radio base stations.
